(19) United States
(12) Patent Application Publication
(10) Pub. No.: US 2016/0360908 A1
(43) Pub. Date: Dec. 15, 2016

(54) BABY FEEDER

(71) Applicants: Amanda Naraine, Jamaica, NY (US); Ariel Moreno, Jamaica, NY (US)

(72) Inventors: Amanda Naraine, Jamaica, NY (US); Ariel Moreno, Jamaica, NY (US)

(21) Appl. No.: 14/739,697

(22) Filed: Jun. 15, 2015

(51) Int. Cl. A47G 19/22; A61J 7/00; B65D 83/00

(52) U.S. Cl. CPC A47G 19/2266; B65D 83/0033; A61J 7/0053

(57) ABSTRACT

A toy baby feeder has a syringe feeding tube formed therein to hold and dispense food to a child. An integral opening formed on a first end of the toy baby feeder is provided to take in and expel the food from the a syringe feeding tube. A plunger disposed within the syringe feeding tube draws the food into the feeding tube through the integral opening and expels the food within the syringe feeding tube through the integral opening to the child. First and second ring shaped finger openings and a third ring shaped finger disposed adjacent to the opening at the second end of the toy baby feeder enable a user to move the plunger into and out of the feeding tube with one hand.

### TECHNICAL FIELD OF THE INVENTION

The present invention relates generally to an improved baby feeder. More specifically, the present invention relates to a toy baby feeder which enables a user to take in and dispense food to a child with one hand.

### BACKGROUND OF THE INVENTION

Initially, babies are fed with milk or a nutritionally balanced milk substitute. Except for nursing the baby, the milk is usually delivered by a baby feeder. Traditionally, baby feeders have taken the form of a generally cylindrical bottle (typically, glass or plastic) and a removable nipple closing one end of the bottle. The nipple is commonly secured to the bottle by a threaded circular ring or collar having a central hole through which the nipple protrudes and which holds it securely to the bottle.

As the baby grows, his feeding is supplemented with “solid” foods. These foods are not really solid, but are semi-fluid in nature. These foods include smooth oatmeal, smooth fruit, smooth vegetables and smooth meat, usually chicken. These food materials are pureed and adjusted in viscosity . In manufacture, they are placed in jars and sterilized. A serving of the solid food is spooned from the baby jar into the dish in which it is warmed. Then, the mother uses a small spoon to feed the baby from the dish. In that instance, the mother uses a small spoon, scoops a small amount of this pureed food from the jar, and uses the spoon to place it in the baby's mouth. This feeding often takes place with the baby in a seated, upright position and held in position, as in a high chair. This is usually a two-handed operation because the dish or baby food jar must be held in one hand while the pureed baby food is spooned out. This is particularly true when there is not an adjacent table on which to place the dish or baby food jar.

It is important to monitor the food intake for babies to make sure they are taking the needed nutrition. Because spoon-feeding is messy it is difficult to accurately measure the food that is actually consumed by the infant. It is also difficult to encourage the baby to learn feeding skills using spoon-feeding.

### SUMMARY OF THE INVENTION

According to an embodiment of the present invention, there is disclosed a baby feeder to feed a child. The baby feeder includes a syringe feeding tube formed within a toy baby feeder to hold and dispense food to the child; an integral opening formed on a first end of the toy baby feeder to take in and expel the food from the a syringe feeding tube; a plunger received within an opening at a second end of the toy baby feeder to travel within the syringe feeding tube to draw the food into the feeding tube through the integral opening and to expel the food within the syringe feeding tube through the integral opening to the child; and first and second ring shaped finger openings disposed adjacent to the opening at the second end of the toy baby feeder to support the toy baby feeder while moving the plunger into and out of the feeding tube.

According to another embodiment of the present invention, a method of feeding a child with one hand includes: placing two fingers of a user's hand through first and second ring shaped finger openings disposed adjacent the open end of a syringe feeding tube formed at one end of a toy baby feeder; placing a thumb of the user's hand through a third ring shaped opening at one end of a plunger extending outward from the open end of a syringe feeding tube; moving the plunger through the feeding tube towards an integral opening of the syringe feeding tube at an opposite end of the toy baby feeder by pressing the thumb against the third ring shaped opening while holding the toy baby feeder with the two fingers of the user's hand within the first and second ring shaped openings; placing the integral opening of the toy chamber within a container of a desired food substance; moving the plunger away from the integral opening by pulling of the third ring shaped opening with the thumb while holding the toy baby feeder with the two fingers of the user's hand in the first and second ring shaped finger; and forcing the food out of the integral opening of the toy baby feeder by moving the plunger through the syringe feeding tube towards the integral opening by pressing the thumb against the third ring shaped opening while holding the toy baby feeder with the two fingers of the user's hand within the first and second ring shaped openings.

According to another embodiment of the present invention, a method of feeding a child with one hand, comprising providing a syringe feeding tube which is formed within a child-friendly toy baby feeder for holding and dispensing food to the child; taking in and expelling food through an integral opening formed on a first end of the toy; receiving a plunger within an opening at a second end of the toy baby feeder for travelling within the feeding tube to expel the food within the syringe feeding tube to the child; disposing first and second ring shaped finger openings adjacent to the opening at the second end of the toy baby feeder; and supporting the toy baby feeder by placing two fingers of a user's hand through first and second ring shaped finger openings while moving the plunger into and out of the feeding tube.

### BRIEF DESCRIPTION OF THE DRAWINGS

The structure, operation, and advantages of the present invention will become further apparent upon consideration of the following description taken in conjunction with the accompanying figures (FIGS.). The figures are intended to be illustrative, not limiting. Certain elements in some of the figures may be omitted, or illustrated not-to-scale, for illustrative clarity. The cross-sectional views may be in the form of “slices”, or “near-sighted” cross-sectional views, omitting certain background lines which would otherwise be visible in a “true” cross-sectional view, for illustrative clarity.

In the drawings accompanying the description that follows, both reference numerals and legends (labels, text descriptions) may be used to identify elements. If legends are provided, they are intended merely as an aid to the reader, and should not in any way be interpreted as limiting.

FIG. 1 is a front three dimensional view of the baby feeder with the plunger extended, in accordance with an embodiment of the present invention.

FIG. 2 is an exploded view of the baby feeder, in accordance with an embodiment of the present invention.

FIG. 3 is a cross-sectional view of the baby feeder with the plunger extended, in accordance with an embodiment of the present invention.

FIG. 4 is a cross-sectional view of the baby feeder with the plunger depressed, in accordance with an embodiment of the present invention.

FIG. 5a is a front three dimensional view of the baby feeder with the plunger depressed in a food container, in accordance with an embodiment of the present invention.

FIG. 5b is a front three dimensional view of the baby feeder with the plunger extended in a food container, in accordance with an embodiment of the present invention.

FIG. 5c is a front three dimensional view of the baby feeder in use with a child, in accordance with an embodiment of the present invention.

### DETAILED DESCRIPTION OF THE PREFERRED EMBODIMENTS

In the description that follows, numerous details are set forth in order to provide a thorough understanding of the present invention. It will be appreciated by those skilled in the art that variations of these specific details are possible while still achieving the results of the present invention. Well-known processing steps are generally not described in detail in order to avoid unnecessarily obfuscating the description of the present invention.

In the description that follows, exemplary dimensions may be presented for an illustrative embodiment of the invention. The dimensions should not be interpreted as limiting. They are included to provide a sense of proportion. Generally speaking, it is the relationship between various elements, where they are located, their contrasting compositions, and sometimes their relative sizes that is of significance.

In the drawings accompanying the description that follows, often both reference numerals and legends (labels, text descriptions) will be used to identify elements. If legends are provided, they are intended merely as an aid to the reader, and should not in any way be interpreted as limiting.

A key milestone in the feeding development of a young child is the introduction of solid foods such as purees and other soft mixtures. Babies, or small children like toddlers, are commonly fed these “solid foods” with well-known eating utensils like forks, spoons and knives. Although these standard eating utensils can be easily handled by an adult for feeding to a child, a small child, may have difficulty in grasping the utensil for self-feeding. These utensils typically have a handle and another portion for transporting food that must be properly oriented in order to prevent any spillage. Small children and individuals having disabilities lack the manual dexterity to properly hold standard spoons and forks. Furthermore, such spoons and forks may also be used improperly potentially causing discomfort or injury. Thus, there is a need for a feeding implement that is appropriate for self-feeding by a small child.

The improved baby feeder 10 is intended to reduce mess and save money when feeding a small child. The baby feeder 10 utilizes a syringe feeding tube 12 to dispense food to a child utilizing a plunger 14, and molded within a child-friendly toy baby feeder 16. Children generally have fun and are comfortable playing with toys. The toy baby feeder 16 having a feeding tube incorporated therein is designed to minimize the effect of any discomfort associated with the feeding tube 12 and provide an enjoyable eating experience for the child 15.

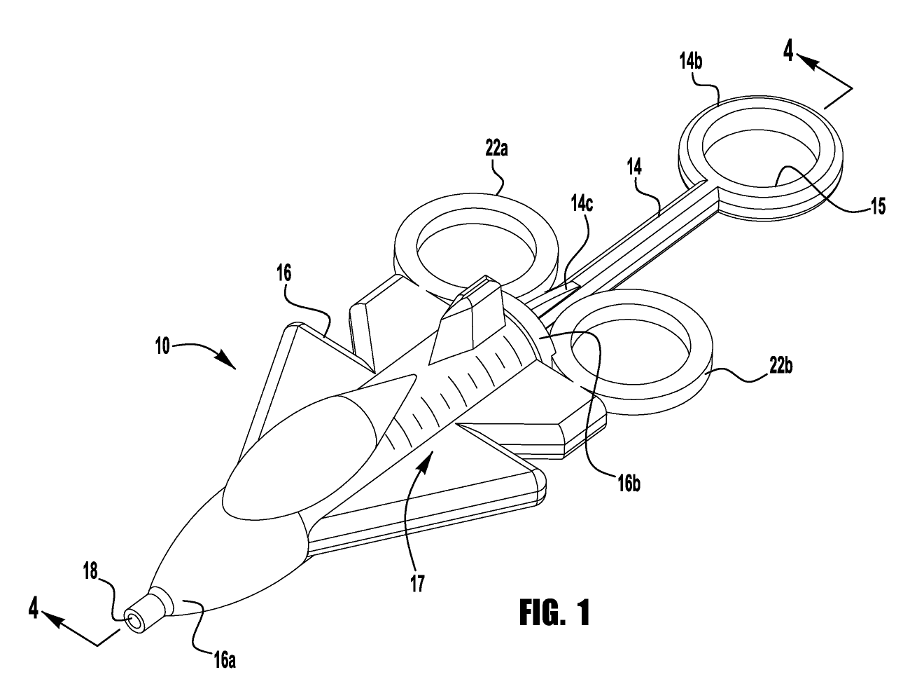

FIG. 1 illustrates a front three dimensional of the improved baby feeder 10. The baby feeder 10 can be produced of a sufficiently strong, medical/food grade plastic, and the like, for example, that can resist being brought to sterilization temperatures a large number of times without significantly deteriorating. The baby feeder 10 may be any desired length, such as length with a range between about 4 inches and 6 inches. The baby feeder 10 includes a toy baby feeder 16 having a molded syringe feeding tube 12 formed therewithin, and an integral opening 18 formed on a first end 16a of the toy baby feeder 16 in open communication with the outlet opening to the feeding tube 12 and an inlet opening 20 to the feeding tube 12 disposed at a second end 16b of the toy baby feeder.

The integral opening 18 is designed to draw in liquid and/or solid foods from a container into the feeding tube 12 and to expel the liquid and/or solid foods from the feeding tube 12, typically into a child's mouth. Although not illustrated, it is within the terms of the embodiment that there be a variety of attachments that may fit onto the integral opening 18, such as a spoon, fork, nipple, and the like. These attachments may be adapted to be secured onto the integral opening 18 by means of threads, a press fit, or any other desired method.

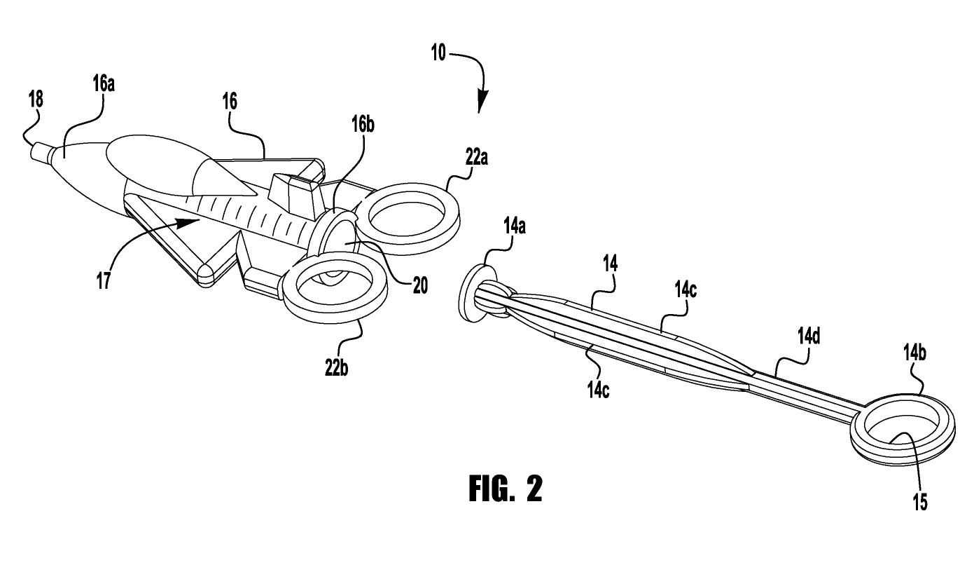

FIG. 2 illustrates an exploded view of the improved baby feeder 10, including the toy baby feeder 16 and the plunger 14. The toy baby feeder 16 is an apparatus for the administration of food to children comprising a toy formed in the shape of a plane. As shown, the toy baby feeder 16 is portrayed as a plane. However, it is within the terms of the embodiment that any desired shape may be utilized, such as a model animal or machine. The toy baby feeder 16 is designed to be lightweight to promote ease of operation and comfortable feeding of the child.

The plunger 14, as best seen in FIG. 2 has an elongated rod 14d with a piston 14a at one end of the rod and a handle 14b formed as a third ring shaped finger opening 15 at the opposite end of the rod. The rod 14d can include a plurality of spaced ridges 14c disposed around and extending outward from the rod. The piston 14a is directed into the inlet opening 20 to the feeding tube 12 at the second end 16b of the baby feeder and moved towards the integral opening 18 formed at the first end 16a of the toy baby feeder 16 by pressing the third ring shaped finger opening 15 towards the inlet opening. The diameter of the piston 14a is approximately equal to the inner diameter of the feeding tube 12 so that a sliding fit exits between the piston and the inner diameter of the feeding tube. The spaced ridges 14c disposed around and extending outward from the rod 14 can also have a sliding fit with the inner diameter of the feeding tube 12.

In operation, the piston 14a forms a partial vacuum between it and the opening 18a so that when the opening 18a is inserted into a container of food or liquid, the food or liquid is drawn into the feeding tube 12 through the inlet opening 20 as the plunger is withdrawn from the feeding tube. Then, when the feeding tube 12 has food or liquid therein, and the piston is moved towards the inlet opening 20 as the plunger is moved into the feeding tube, the food or liquid is expelled through the opening 18.

The toy baby feeder 16 may be constructed of a transparent outer material, which may include graduated scale markings 17 along the outer surface of the toy baby feeder, allowing the user to see into the molded syringe feeding tube 12. This transparency allows for observing and measuring the drawn food inside the syringe feeding tube 12 by the plunger 14 to be fed to the child. The scale markings 17 can be in any form, including major lines with incremental lines therebetween, indicating volumetric contents in milliliters, ounces, tablespoons, teaspoons, etc., and combinations of such measuring indicia.

As shown in FIGS. 1 and 2, there are first and second ring shaped finger openings 22a and 22b disposed adjacent to opening 20 at the second end 16b of the toy baby feeder 16. Ring shaped finger openings 22a and 22b are formed to provide a finger hold for two fingers of a user of the baby feeder 10. The molded syringe feeding tube 12 is formed within the toy baby feeder 16 and stores the food to be fed to the child.

The syringe feeding tube 12 may have any appropriate dimensions, such as a circumference with a range between about 1 inch and 2 inches, and length with a range between about 2 inches and three inches. Preferably, as noted above, food products entering and exiting the feeding tube 12 can be viewed through the transparency in the toy baby feeder 16, as they are received or expelled. As illustrated, the syringe feeding tube 12 has smooth interior walls. However, it is within the terms of the embodiment that there be gear ratchets on the walls of the syringe feeding tube 12. In this embodiment, the plunger 14 travels along the feeding tube 12 encountering the gear ratchets, which are configured to present discernible resistance and audible clicks, and meter food products. Every gradient of the gear rack can be spaced such that the feeding tube 12 expels a predetermined, metered amount of food product through the integral opening 18.

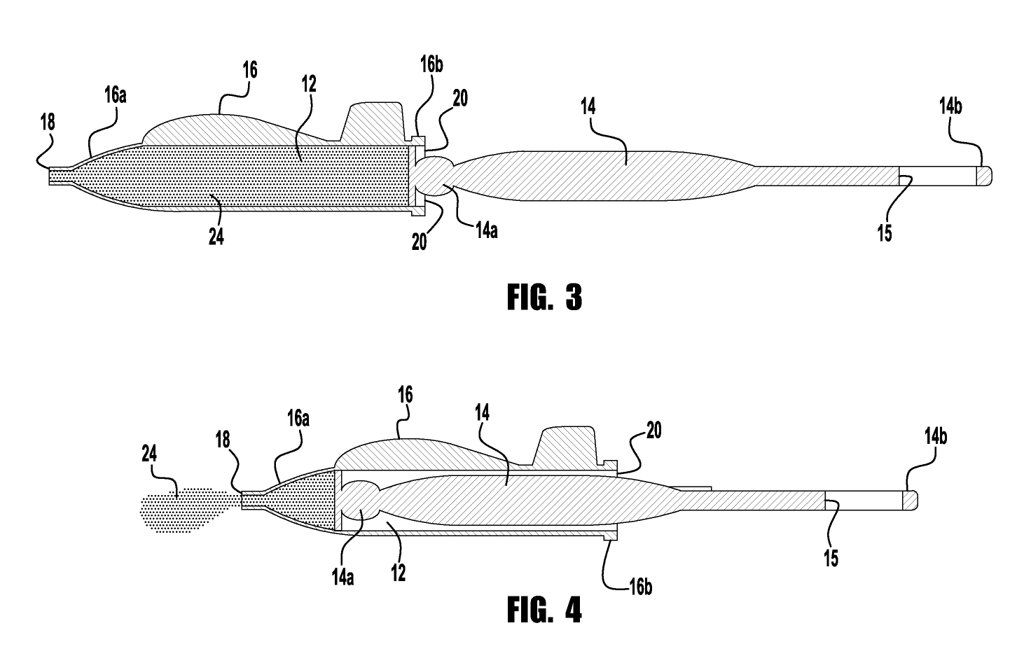

As seen in FIGS. 3 and 4, the plunger 14 is designed to be slidably disposed within the syringe feeding tube 12, such that it fits tightly within the tube. The plunger 14 enters the feeding tube 12 through the opening 20. The opening 20 through which the plunger 14 is inserted and removed is typically sized so that the plunger fits relatively snug within the feed tube 12, so it does not slide freely. In this way, the desired length of the plunger 14 extending out from the feed tube 12 can be adjusted by the person administering the food and it can stay in this location while being used. The ring shaped opening 15 is disposed on an end of the plunger 14 for controlling movement of the plunger within the feeding tube 12.

In general terms, the end 18 is inserted into a container of food, the plunger 14 is pulled back forming a suction between the piston 14a and the opening 18 to draw the food 24 into the feeding tube 12 of the toy baby feeder 16, and the plunger 14 is then pushed into the feeding tube whereby the piston forces the food towards the opening so that the food is expelled through the opening whereby the contents within the chamber can be expelled into the mouth of the child.

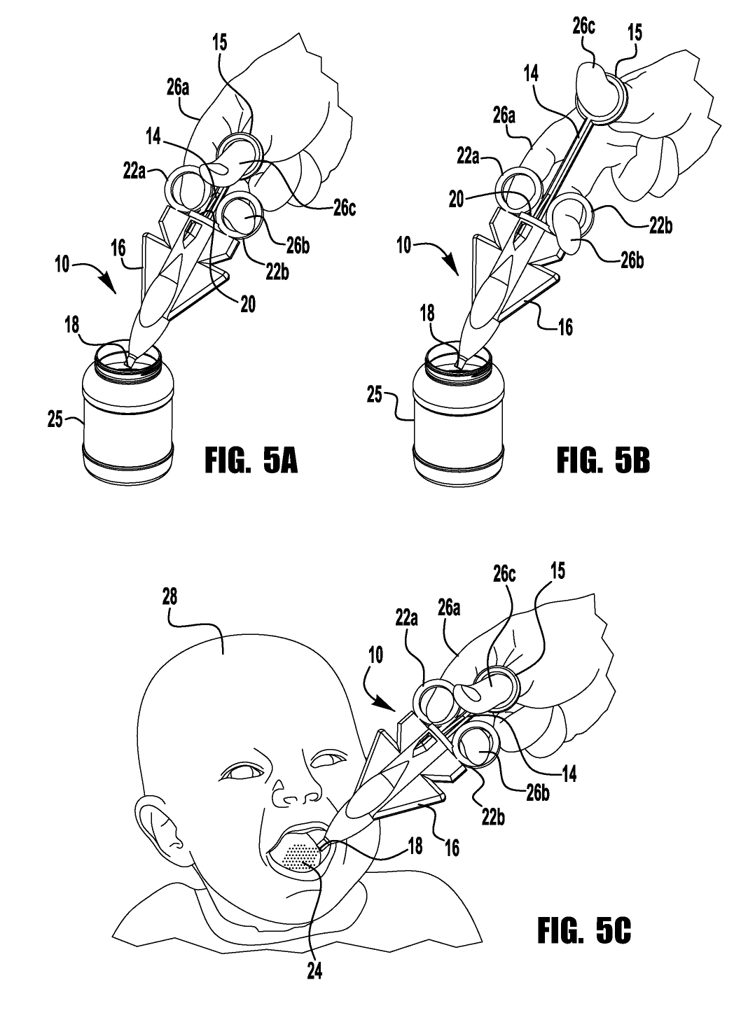

FIGS. 3, 4, 5a, 5b, and 5c illustrate the use of the improved baby feeder 10. Initially, the plunger 14 is exterior to the toy baby feeder 16 and the feeding tube 12 is empty. The plunger 14 works in the traditional way in that the plunger is slid into the feeding tube 12 via opening 20 of the toy baby feeder 16. As seen in FIG. 5a, the user's first finger 26a and middle finger 26b are placed through ring shaped finger openings 22a and 22b, respectively. The user's thumb 26c is placed through ring shaped opening 15 of the plunger 14. The integral opening 18 of the baby feeder 10 is placed within a container 25 of a desired food substance 24, and the plunger is slid into the feeding tube 12 by pressing the thumb 26c against the ring shaped opening 15.

Then, as seen in FIG. 5b, the plunger 14 is slid away from the integral opening 18 by pulling the thumb 26c against the ring shaped opening 15 while the user's first finger 26a and middle finger 26b are placed through ring shaped finger openings 22a and 22b, respectively. This rearward sliding of the plunger 14 creates a vacuum between the opening 18 and the piston 14a within the feeding tube 12 so that the food 24 is drawn into the feeding tube via the integral opening 18 as a result of the vacuum so created, as seen in FIG. 3.

Once the feeding tube 12 is filled with a desired amount of the food 24, as seen in FIG. 3, the food 24 is forced out of the end 18 of the feeding tube 12 by pressing on the handle 14b via ring shaped opening 15 with thumb 26c while holding the feeding tube 12 in place with the user's first finger 26a and middle finger 26b within ring shaped finger openings 22a and 22b, respectively. As seen in FIG. 4 and 5c, this in turn causes the plunger 14 to be pushed through the feeding tube 12 toward the integral opening 18 at the end of the toy baby feeder 16, thereby forcing the food 24 back out of the opening 18, and into a child's 28 mouth. In this manner, the improved baby feeder 10 may be operated with only one hand.

Although the invention has been shown and described with respect to a certain preferred embodiment or embodiments, certain equivalent alterations and modifications will occur to others skilled in the art upon the reading and understanding of this specification and the annexed drawings. In particular regard to the various functions performed by the above described components (assemblies, devices, etc.) the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more features of the other embodiments as may be desired and advantageous for any given or particular application.

In the claims:

1. A baby feeder to feed a child, comprising:
a syringe feeding tube formed within a toy baby feeder to hold and dispense food to the child;
an integral opening formed on a first end of the toy baby feeder to take in and expel the food from the a syringe feeding tube;
a plunger received within an opening at a second end of the toy baby feeder to travel within the syringe feeding tube to draw the food into the feeding tube through the integral opening and to expel the food within the syringe feeding tube through the integral opening to the child; and
first and second ring shaped finger openings disposed adjacent to the opening at the second end of the toy baby feeder to support the toy baby feeder while moving the plunger into and out of the feeding tube.

2. The baby feeder of claim I wherein the plunger is slidably disposed within the syringe feeding tube such that it fits tightly within the syringe feeding tube.

3. The baby feeder of claim 1 wherein the plunger has a third ring shaped opening at one end and a piston at the opposite end.

4. The baby feeder of claim 3 wherein the third ring shaped opening in combination with the first and second ring shaped finger openings disposed adjacent to the opening at the second end of the toy baby feeder enable a person to operate the baby feeder with a single hand.

5. The baby feeder of claim 3 wherein the piston has sliding fit with the interior walls of the syringe feeding tube.

6. The baby feeder of claim 5 wherein the syringe feeding tube has smooth interior walls.

7. The baby feeder of claim 6 further including a plurality of spaced ridges disposed around and extending outward from the rod wherein the ridges have a sliding fit with the interior walls of the syringe feeding tube.

8. The baby feeder of claim 1 wherein the toy baby feeder is constructed of a transparent outer material which allows for observing the drawn food inside the syringe feeding tube formed within the toy baby feeder.

9. The baby feeder of claim 8 wherein the toy baby feeder includes graduated scale markings along the outer surface of the toy baby feeder for measuring the drawn food inside the syringe feeding tube formed within the toy baby feeder.

10. A method of feeding a child with one hand, comprising:
placing two fingers of a user's hand through first and second ring shaped finger openings disposed adjacent the open end of a syringe feeding tube formed at one end of a toy baby feeder;
placing a thumb of the user's hand through a third ring shaped opening at one end of a plunger extending outward from the open end of a syringe feeding tube;
moving the plunger through the feeding tube towards an integral opening of the syringe feeding tube at an opposite end of the toy baby feeder by pressing the thumb against the third ring shaped opening while holding the toy baby feeder with the two fingers of the user's hand within the first and second ring shaped openings;
placing the integral opening of the toy chamber within a container of a desired food substance;
moving the plunger away from the integral opening by pulling of the third ring shaped opening with the thumb while holding the toy baby feeder with the two fingers of the user's hand in the first and second ring shaped finger; and
forcing the food out of the integral opening of the toy baby feeder by moving the plunger through the syringe feeding tube towards the integral opening by pressing the thumb against the third ring shaped opening while holding the toy baby feeder with the two fingers of the user's hand within the first and second ring shaped openings.

11. The method of claim 10 further including:
providing a piston at an end of the plunger; and
moving the piston within the syringe feeding tube by moving the plunger through the feeding tube by pushing and pulling of the third ring shaped opening with the thumb while holding the toy baby feeder with the two fingers of the user's hand in the first and second ring shaped finger.

11. The method of claim 11 including providing a piston formed at an end of the plunger having a diameter that has a sliding fit with interior walls of the syringe feeding tube to facilitate the moving of the food within the feeding tube.

13. The method of claim 12 further including providing including a plurality of spaced ridges disposed around and extending outward from the rod forming the plunger wherein the ridges have a sliding fit with the interior walls of the syringe feeding tube.

14. The method of claim 10 including observing the drawn food inside the syringe feeding tube formed within the toy baby feeder through transparent material forming the toy baby feeder with the syringe feeding tube formed therein.

15. The method of claim 14 further including providing graduated scale markings along an outer surface of the toy baby feeder and measuring the amount of food drawn into the syringe feeding tube.

16. A method of feeding a child with one hand, comprising:
providing a syringe feeding tube which is formed within a child-friendly toy baby feeder for holding and dispensing food to the child;
taking in and expelling food through an integral opening formed on a first end of the toy;
receiving a plunger within an opening at a second end of the toy baby feeder for travelling within the feeding tube to expel the food within the syringe feeding tube to the child;
disposing first and second ring shaped finger openings adjacent to the opening at the second end of the toy baby feeder: and
supporting the toy baby feeder by placing two fingers of a user's hand through first and second ring shaped finger openings while moving the plunger into and out of the feeding tube.

17. The method of claim 16 further including placing a thumb of the user's hand through a third ring shaped opening at one end of a plunger extending outward from the open end of a syringe feeding tube.

18. The method of claim 17 including providing a piston formed at an opposite end of the plunger from the third ring shaped opening at one end of a plunger that facilitates the moving of the food within the feeding tube.

19. The method of claim 18 including providing the piston with a diameter that has a sliding fit with interior walls of the syringe feeding tube to facilitate the moving of the food within the feeding tube.

20. The method of claim 19 further including providing ridges disposed along the length of the plunger and ensuring a sliding fit with the interior walls of the syringe feeding tube.
